(19) United States
(12) Patent Application Publication
(10) Pub. No.: US 2010/0287778 A1
(43) Pub. Date: Nov. 18, 2010

(54) COMB RAZOR COMBINATION

(76) Inventor: MICHAEL RONDA, MONOHAWKIN, NJ (US)

Correspondence Address: LAW OFFICE OF JERRY D. HAYNES , P.A, P.O. Box 350392, Fort Lauderdale, FL, 33335, US

(21) Appl. No.: 12/467,219

(22) Filed: May 15, 2009

(51) Int. Cl. B26B 21/12

(52) U.S. Cl. 30/30

(57) ABSTRACT

The present invention relates to a comb razor device for hairstyling comprising: a handle; a plurality of teeth extending from the handle; a razor blade, where said razor is capable of being engaged between a first position and a second position, said first position being above the plurality of teeth and said second position being between the plurality of teeth; and an engaging button, where said engaging button maneuvers the razor blade between the first position and second position. In one exemplary embodiment, the comb razor device includes a release button to release the razor blade from the comb razor device for replacement purposes.

### BACKGROUND OF THE INVENTION

1. Field of Invention

The present invention relates to a combined comb razor that effectively combines two hair styling tools in to one.

2. Description of Related Art

Combs are generally flat devices that include a plurality of teeth and are used for straightening and styling of hair. Combs may be manufactured of various materials such as wood or plastic. The teeth of a comb may be wide or thin and many hair-dressing combs include thinly spaced teeth with a long tapered handle. Combs are one of the principal tools used by hair stylists in designing and creating various hairstyles.

Hair styling may include curling, straightening, cutting, detangling and trimming of a subject's hair. The cutting of a subject's hair may involve the interchanging of multiple styling tools by a hair stylist. On occasion it may be necessary to retain tension within a lock of hair in order to effectively cut the hair for a particular hairstyle. Presently there does not exist a hair styling device that enables the hair stylist to maintain tension within the hair while cutting the hair with a cutting instrument such as a razor. Usually a hair stylist must grasp a lock of hair with his free hand, place his comb in a hand holding the hair in a taut position and than must engage the hair with a razor with the free hand that is not holding the hair in the taut position. Consequently the cutting, combing and straightening of hair by a hair stylist can be quite a cumbersome activity and therefore a need for a combined device which utilizes a comb that is able to cut as the hair is held in a tense position would be conducive to alleviating some of the problems encountered by hair stylists.

### SUMMARY OF THE INVENTION

The present invention relates to a comb razor device for hairstyling comprising: a handle; a plurality of teeth extending from the handle; a razor blade, where said razor is capable of being engaged between a first position and a second position, said first position being above the plurality of teeth and said second position being between the plurality of teeth; and an engaging button, where said engaging button maneuvers the razor blade between the first position and second position. The comb razor device according to the present invention may further include a means to release the razor blade from the comb razor device and in one exemplary embodiment the release means includes a release button. The razor blade may include a first end, a second end and a cutting edge, where said first end begins at the point where the teeth and handle meet, said second end extends into a portion of the plurality of teeth, and the cutting edge is perpendicular to the plurality of teeth.

### BRIEF DESCRIPTION OF DRAWINGS

FIG. 1A depicts a side view of the combined razor comb according to the present invention.

FIG. 1B depicts side view of the comb razor according to the present invention where the razor is engaged for cutting.

FIG. 2A depicts a means to release and secure the razor within the comb razor combination.

FIG. 2B has a detailed view of the razor attached to the handle of the comb razor combination according to the present invention.

### DETAILED DESCRIPTION

The present invention provides a combined hair styling tool which has combined a comb with a razor where the razor may be actuated into a cutting position as desired by the hair stylist. The primary function of the comb razor combination is to provide a hair stylist with a multi-functional comb and razor apparatus in order to alleviate some of the interchanging of hair styling tools that a hair stylist encounters while performing hair styling functions. The comb razor combination of the present invention provides for a razor within the teeth of a comb and therefore the hair may be cut as desired by the hair stylist with one multi-functional tool.

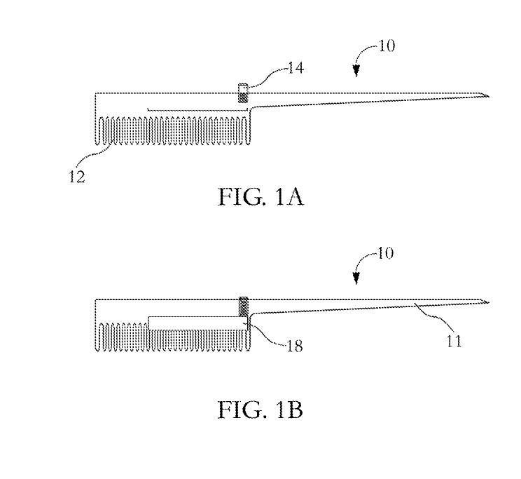

FIG. 1A depicts the comb razor device according to the present invention whereas the razor is in a non-engaged state or non-cutting position. The comb razor device 10 includes a button 14 which actuates the razor into a cutting position and a plurality of teeth 12 along the combing edge of the comb. As shown in FIG. 1A the comb razor device 10 may be utilized strictly as a comb for the conventional combing tasks associated with hair styling. FIG. 1B depicts a razor 18 engaged into the teeth 12 of the comb 10. The comb razor device 10 also includes a handle 11 that is used to manipulate the comb razor device 10 as desired by the hair stylist. The handle 11 depicted has a long thin spike type shape, however the handle 11 may be configured in other shapes and styles. The button 14 is pushed downward and therefore engages the razor 18 into a cutting position as depicted in FIG. 1B.

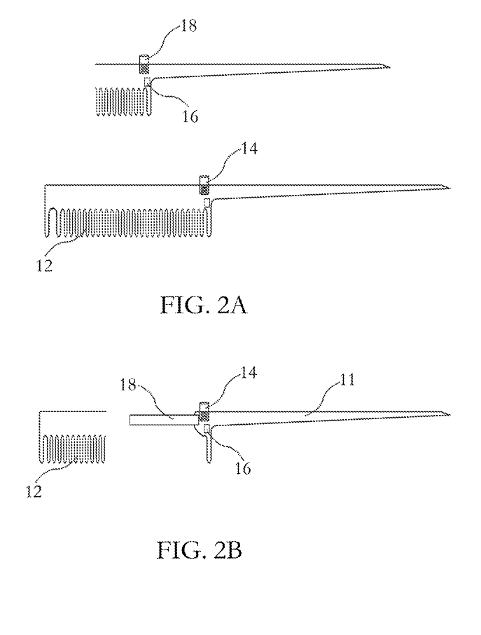

Over time a user will need to replace the razor 18, because the razor's edge will more than likely dull after continued use. FIG. 2A depicts a means to release the razor blade from the combined comb razor device 10. A side button 16 releases the razor 18 in an upward position and allows for the razor 18 to be removed from the comb razor device 10 at a point where the teeth 12 meet the handle 11. The release point of the razor 18 is adjacent to the button 14. The release button 16 allows for the release of the razor 18 for replacement purposes.

FIG. 2B shows the position of the razor 18 extending from the handle 11 of the comb razor device 10, the engaging button 14 and the release button 16. When the razor 18 is not engaged for cutting it remains in the up position or non-cutting position above the teeth 12. The engaging button 14 pushes the razor 18 downward between the teeth 12 and allows the user to cut hair that may be in the teeth 12 of the comb razor device 10.

The comb razor combination device combines the functions of a comb and razor and allows a hair stylist to effectively cut a lock of hair without using multiple tools. The combined comb razor device 10 is equipped with a razor blade placed between the teeth of the comb which may be placed into a cutting position with an engaging button. The razor may also be released for removal and changing with a separate release button. This unique design of a comb razor enables a hair stylist to comb, cut and trim a lock of hair as desired without the need for an additional styling tool.

What is claimed is:

1. A comb razor device for hairstyling comprising:
a. a handle;
b. a plurality of teeth extending from the handle;
c. a razor blade, where said razor is capable of being engaged between a first position and a second position, said first position being above the plurality of teeth and said second position being between the plurality of teeth; and
d. an engaging button, where said engaging button maneuvers the razor blade between the first position and second position.

2. The comb razor device according to claim 1, further comprising a means to release the razor blade from the comb razor device.

3. The comb razor device according to claim 2, where said means includes a release button.

4. The comb razor device according to claim 1, where said razor blade includes a first end, a second end and a cutting edge, where said first end begins at the point where the teeth and handle meet, said second end extends into a portion of the plurality of teeth, and the cutting edge is perpendicular to the plurality of teeth.

5. The comb razor device according to claim 3, where the razor blade releases above the plurality of teeth and enables for the replacement of the razor blade.

6. The comb razor device according to claim 1, where said first position is a non-cutting position and said second position is a cutting position.

7. The comb razor device according to claim 1, where said handle is configured in a long spike like shape.
